(19) United States
(12) Patent Application Publication
(10) Pub. No.: US 2010/0020559 A1
(43) Pub. Date: Jan. 28, 2010

(54) LAMP SOCKETS

(76) Inventors: Robert H. C. Janssen, Beek (NL); Hans K. Dijk Van, Sittard (NL)

Correspondence Address: NIXON & VANDERHYE, PC, 901 NORTH GLEBE ROAD, 11TH FLOOR, ARLINGTON, VA, 22203, US

(21) Appl. No.: 12/307,990

(22) PCT Filed: Jul. 9, 2007
(86) PCT No.: PCT/EP07/06083

§ 371 Date: Aug. 11, 2009

(30) Foreign Application Priority Data
Jul. 11, 2006 (EP) 06014339.3
Dec. 27, 2006 (EP) 06026927.1

(51) Int. Cl. B60Q 1/26; F21V 19/00

(52) U.S. Cl. 362/487; 362/382

(57) ABSTRACT

The invention relates to a lamp socket consisting at least partially of a plastic composition having a through plane thermal conductivity of at least 0.5 W/m.K. The plastic composition may comprise a thermoplastic polymer and a thermally conductive filler and/or a thermally conductive fibrous material. For example, the plastic composition may comprise a semicrystalline polyamide having a melting point of at least 200° C., glass fibres and boron nitride. The tendency to fogging is reduced.

This invention relates to lamp sockets made of a plastic composition and in particular to lamp sockets that can be used in automotive lamp assemblies for automotive exterior lighting applications. Still more particularly, it relates to a lamp socket having a reduced tendency to outgas products that can deposit on the reflector and the lens of a lamp body thereby reducing the efficiency of the lamp. This phenomenon of deposit formation resulting in haze production and reduction of the lamp efficiency is also known as fogging.

Such a lamp socket is known from US2004/0165411A1. US2004/0165411A1 describes that plastics used in conventional incandescent and other heat-producing lamp applications have been selected for their ability to work at elevated temperatures without softening or degradation of the plastic. For example, U.S. Pat. No. 4,795,939 to F. Eckhardt et al. discloses the use of a high-temperature resistant plastic such as Ultem 2300™ and Ryton™ in a high-pressure discharge automotive headlamp. Polyetherimides such as Ultem™ have also been used in other vehicle headlamp applications, such as disclosed in U.S. Pat. No. 5,239,226 to D. Seredich et al., U.S. Pat. No. 4,795,388 to C. Coliandris et al., and U.S. Pat. No. 4,751,421 to A. Braun et al., each of which disclose a halogen headlamp socket, or lamp holder, made of Ultem™. As another example, U.S. Pat. No. 5,889,360 to M. Frey et al. discloses an arc tube having an integral socket, made from polyetherimide.

As is described in US2004/0165411A1, a known problem of plastics used in exterior vehicle lighting applications is outgassing, which causes fogging of the lenses and/or reflectors which can adversely affect the appearance, aesthetics, and photometric performance of the overall lamp assembly. For example, U.S. Pat. No. 6,012,830 to Frazier discloses a light shield for a vehicle headlamp that uses a titanium carbide coating that reportedly does not outgas over the life of the headlamp. Outgassing has been traced to the release of volatiles from the resin as a result of the polymerization process of some resins. This is particularly true where exterior vehicle incandescent lamps are used in conjunction with a plastic lamp socket, since the thermally output of the lamps can raise the temperature of the socket to 200-450° F., or 90-230° C.

The solution to the problem of outgassing and fogging provided in US2004/0165411A1 is a lamp socket assembly wherein the plastic socket is made from polyetherimide and comprises an opening to receive a press-sealed end of an incandescent lamp. A plurality of electrical contacts is located in the opening and the socket also includes a plurality of terminals, each of which is electrically connected to one of the contacts. The socket includes at least one flexible retaining member located at the opening to engage the press-sealed end of the incandescent lamp and thereby retain the lamp within the opening.

This solution is very complex and severally restricts the designer of lamp assemblies in his freedom to design lamp sockets and lamp sockets assemblies. A further disadvantage of the known lamp socket is that the thermoplastic polymer, from which is made, polyetherimide is expensive.

The aim of the present invention is to provide a lamp socket that shows reduced fogging and/or allows the use of less expensive materials meanwhile being less restrictive for the lamp assembly design or even keeping open full design freedom of the designer of lamp assemblies.

This aim has been achieved with the lamp socket according to the invention, wherein the lamp socket consists at least partially of a plastic composition having a through plane thermal conductivity of at least 0.5 W/m.K. The effect of the plastic composition having a through plane thermal conductivity of at least 0.5 W/m.K in the lamp socket according to the invention is that the tendency to fogging is reduced. An additional advantage of the lamp socket according to the invention is that for less critical applications cheaper polymers can be used in the plastic composition, which cheaper polymers would give just too much outgassing and fogging in a conventional lamp socket made of a non-thermally conductive plastic composition. A further advantage is that due to the reduced fogging of the lamp socket according to the invention, the design freedom for lamp sockets and lamp assemblies is widened compared to the solution of the cited prior art US2004/0165411A1.

With the term ‘consists at least partially’ in the construction ‘the lamp socket consists at least partially of a plastic composition’ is herein understood that the lamp socket is integrally made of and fully consists of the plastic composition, or that a part or parts of the lamp socket is made of and fully consists of the plastic composition, whereas an other part or other parts of the lamp socket can have been made of another composition.

Preferably, the lamp socket is integrally made of and fully consists of the plastic composition having a through plane thermal conductivity of at least 0.5 W/m.K.

The thermal conductivity of a plastic composition is herein understood to be a material property, which can be orientation dependent and which also depends on the history of the composition. For determining the thermal conductivity of a plastic composition, that material has to be shaped into a shape suitable for performing thermal conductivity measurements. Depending on the composition of the plastic composition, the type of shape used for the measurements, the shaping process as well as the conditions applied in the shaping process, the plastic composition may show an isotropic thermal conductivity or an anisotropic, i.e. orientation dependent thermal conductivity. In case the plastic composition is shaped into a flat rectangular shape, the orientation dependent thermal conductivity can generally be described with three parameters: Λ_{⊥}, Λ_{//} and Λ_{±}. The orientationally averaged thermal conductivity (Λₒₐ) is herein defined according to formula (I):

Λₒₐ=⅓(Λ_{⊥}+Λ_{//}+Λ_{±}), (I)

wherein
Λ_{⊥} is the through-plane thermal conductivity,
Λ_{//} is the in-plane thermal conductivity in the direction of maximum in-plane thermal conductivity, also indicated herein as parallel or longitudinal thermal conductivity and
Λ_{±} is the in-plane thermal conductivity in the direction of minimum in-plane thermal conductivity.

It is noted that the through-plane thermal conductivity is indicated elsewhere also as “transversal” thermal conductivity.

The number of parameters can be reduced to two or even to one depending on whether the thermal conductivity is anisotropic in only one of the three directions or even isotropic. In case of an plastic composition with a dominant unidirectional orientation of thermal conductive fibres in one orientation, Λ_{//} can be much higher than Λ_{±}, whereas Λ_{±} might be very close or even equal to Λ_{⊥}. In the latter case the definition of the orientationally averaged thermal conductivity (Λₒₐ) reduces to formula (II):

Λₒₐ=⅓(2Λ_{⊥}+Λ_{//}) (II)

In case of an plastic composition with a dominant parallel orientation of plate-like particles in plane with the planar orientation of the plate, the plastic composition may show an isotropic in-plane thermal conductivity, i.e. Λ_{//} is equal to Λ_{±}. In that case Λ_{//} and Λ_{±} can be represented by one parameter, Λ_{≡}, and the definition of the orientationally averaged thermal conductivity (Λₒₐ) reduces to formula (III):

Λₒₐ=⅓(Λ_{⊥}+2Λ_{≡}) (III)

In case of an plastic composition with an overall isotropic thermal conductivity, Λ_{⊥}, Λ_{//} and Λ_{±} are all equal and identical to the isotropic thermal conductivity Λ. In that case the definition of the orientationally averaged thermal conductivity (Λₒₐ) reduces to formula (IV)

Λₒₐ=Λ (IV)

The orientationally averaged thermal conductivity can be determined by measurement of the orientation dependent thermal conductivities Λ_{⊥}, Λ_{//} and Λ_{±}. For measurement of Λ_{⊥}, Λ_{//} and Λ_{±}, samples with dimensions of 80×80×1 mm were prepared from the material to be tested by injection moulding using an injection moulding machine equipped with a square mould with the proper dimensions and a film gate of 80 mm wide and 1 mm high positioned at one side of the square. Of the 1 mm thick injection molded plaques the thermal diffusivity D, the density (ρ) and the heat capacity (Cp) was determined.

The thermal diffusivity was determined in a direction in-plane and parallel (D_{//}) and in-plane and perpendicular (D_{±}) to the direction of polymer flow upon mold filling, as well as through plane (D_{⊥}), according to ASTM E1461-01 with Netzsch LFA 447 laserflash equipment. The in-plane thermal diffusivities D_{//} and D_{±} were determined by first cutting small strips or bars with an identical width of about 1 mm wide from the plaques. The length of the bars was in the direction of, respectively perpendicular to, the polymer flow upon mold filling. Several of these bars were stacked with the cut surfaces facing outwards and clamped very tightly together. The thermal diffusivity was measured through the stack from one side of the stack formed by an array of cut surfaces to the other side of the stack with cut surfaces.

The heat capacity (Cp) of the plates was determined by comparison to a reference sample with a known heat capacity (Pyroceram 9606), using the same Netzsch LFA 447 laserflash equipment and employing the procedure described by W. Nunes dos Santos, P. Mummery and A. Wallwork, Polymer Testing 14 (2005), 628-634.

From the thermal diffusivity (D), the density (ρ) and the heat capacity (Cp), the thermal conductivity of the molded plaques was determined in a direction parallel (Λ_{//}) and perpendicular (Λ_{±}) to the direction of polymer flow upon mold filling, as well as perpendicular to the plane of the plaques (Λ_{⊥}), according to formula (V):

Λₓ=Dₓ*ρ*Cp (V)

wherein x=//, ± and ⊥, respectively.

The through plane thermal conductivity as well as the orientationally averaged thermal conductivity of the plastic composition of which the lamp socket according to the invention is made can vary over a wide range. In case the plastic composition has an isotropic thermal conductivity, the orientationally averaged thermal conductivity being equal to the through plane thermal conductivity, suitably also is at least 0.5 W/m.K, while in case the plastic composition has an anisotropic thermal conductivity, the orientationally averaged thermal conductivity can be much higher than the through plane thermal conductivity.

Preferably, the plastic composition has a through plane thermal conductivity of at least 0.75 W/m.K, more preferably at least 1 W/m.K or even 1.5 W/m.K, and most preferably at least 2 W/m.K. The hrough plane thermal conductivity may be as high as 3 W/m.K or even higher, but this brings little further improvement in the reduction of fogging. Also preferably, the orientationally averaged thermal conductivity is at least 1 W/m.K, more preferably at least 2 W/m.K, and still more preferably at least 2.5 W/m.K. The advantage of a higher minimal orientationally averaged thermal conductivity is that the problem of fogging is further reduced.

The orientationally averaged thermal conductivity of the plastic composition may be as high as 25 W/m.K and even higher, but an orientationally averaged thermal conductivity value over 25 W/m.K does not give a significant additional contribution to the reduction of fogging. Furthermore, plastic compositions with such a high thermal conductivity generally have low mechanical and/or bad flow properties making these materials less suitable for making lamp sockets. In line with that the plastic composition of which the lamp socket according to the invention is made preferably has an orientationally averaged thermal conductivity of at most 25 W/m.K, more preferably at most 15 W/m.K and still more preferably at most 10 W/mK. The advantage of lower maximum orientationally averaged thermal conductivity is that the lamp socket can be designed with thinner parts with sufficient mechanical strength. Very suitably, the orientationally averaged thermal conductivity is in the range of 3-6 W/m.K. Surprisingly the problem of fogging is already substantially reduced when the lamp socket is made of a plastic composition having such limited orientationally averaged thermal conductivity.

In analogy to the orientationally averaged thermal conductivity, an average in-plane thermal conductivity (Λᵢₚₐ) can be defined according to formula (VI):

Λᵢₚₐ=½(Λ_{//}+Λ_{±}), (VI)

In a preferred embodiment of the invention, the plastic composition has an anisotropic thermal conductivity with an average in-plane thermal conductivity Λᵢₚₐ being larger than the through-plane thermal conductivity Λ_{⊥}. More preferably, the average in-plane thermal conductivity Λᵢₚₐ of the plastic composition is at least 2 times, more preferably at least 3 times the through-plane thermal conductivity Λ_{⊥}. The advantage of an anisotropic thermal conductivity with such a higher average in-plane thermal conductivity is also that the fogging of the lamp socket is further reduced.

A lamp socket with an anisotropic thermal conductivity can be made with an injection moulding process from a plastic composition comprising thermally conductive fibres and/or thermally conductive platelets.

In another preferred embodiment of the invention, the plastic composition has an anisotropic in-plane thermal conductivity, with a maximum in-plane thermal conductivity Λ_{//} higher than the orientationally averaged thermal conductivity Λₒₐ. Even more preferably, the maximum in-plane thermal conductivity Λ_{//} of the plastic composition is at least 2 times, more preferably at least 3 times the orientationally averaged thermal conductivity Λₒₐ. The advantage of such a higher maximum in-plane thermal conductivity Λ_{//} is that the fogging of the lamp socket is further reduced.

A lamp socket with an anisotropic in-plane thermal conductivity (i.e. with Λ_{//} differing from Λ_{±}) can be made with an injection moulding process from a plastic composition comprising thermally conductive fibres.

Also more preferably the maximum in-plane thermal conductivity of the plastic composition the lamp socket is at most 25 W/m.K, more preferably at most 20 W/m.K. The advantage of lower maximum in-plane thermal conductivity is less thermally conductive material is needed in the thermoplastic composition and the lamp socket can be designed with thinner parts, while retaining good mechanical properties.

For making the lamp socket according to the invention a thermally conductive plastic composition is used. Although for the thermally conductive plastic composition a thermally conductive polymer may be used, such materials are not widely available and generally very expensive. Suitably, the thermally conductive plastic composition comprises a polymer and thermally conductive material dispersed in the polymer. The plastic composition may comprise, next to the polymer material and the thermally conductive material, other components. As the other components, the thermally conductive material may comprise any auxiliary additive used in conventional plastic compositions for making moulded plastic parts.

The polymer in the thermally conductive plastic composition used in the lamp socket according to the invention can in principle be any polymer that is suitable for making thermal conductive plastic compositions. Suitably, the polymer shows limited outgassing at the use temperature of the intended lamp socket. The polymer that is used in the lamp socket according to the invention can be any thermoplastic polymer that, in combination with the thermally conductive material, and the optional other components, is able to work at elevated temperatures without significant softening or degradation of the plastic and can comply with the mechanical and thermal requirements for the lamp socket. These requirements will depend on the specific application and design of the lamp socket. The compliance with such requirements can be determined by the person skilled in the art of making moulded plastic parts by systematic research and routine testing.

Preferably, the plastic composition in the lamp socket according to the invention has a heat distortion temperature, measured according to ISO 75-2, nominal 0.45 Mpa stress applied (HDT-B), of at least 180° C., more preferably at least 200° C., 220° C., 240° C., 260° C., or even at least 280° C. The advantage of the plastic composition having a higher HDT is that the lamp socket has a better retention of mechanical properties at elevated temperature and the lamp socket can be used for applications more demanding in mechanical and thermal performance.

Suitable polymers that can be used include thermoplastic polymers and thermoset polymers, such as thermoset polyester resins and thermoset epoxy resins.

Preferably, the polymer comprises a thermoplastic polymer.

The thermoplastic polymer suitably is an amorphous, a semi-crystalline or a liquid crystalline polymer, an elastomer, or a combination thereof. Liquid crystal polymers are preferred due to their highly crystalline nature and ability to provide a good matrix for the filler material. Examples of liquid crystalline polymers include thermoplastic aromatic polyesters.

Suitable thermoplastic polymers that can be used in the matrix are, for example, polyethylene, polypropylene, acrylics, acrylonitriles, vinyls, polycarbonate, polyesters, polyesters, polyamides, polyphenylene sulphides, polyphenylene oxides, polysulfones, polyarylates, polyimides, polyethertherketnes, and polyetherimides, and mixtures and copolymers thereof.

Suitable elastomers include, for example, styrene-butadiene copolymer, polychloroprene, nitrite rubber, butyl rubber, polysulfide rubber, ethylene-propylene terpolymers, polysiloxanes (silicones), and polyurethanes.

Preferably, the thermoplastic polymer is a chosen from the group consisting of polyesters, polyamides, polyphenylene sulphides, polyphenylene oxides, polysulfones, polyarylates, polyimides, polyethertherketones, and polyetherimides, and mixtures and copolymers thereof.

Suitable polyamides include both amorphous and semi-crystalline polyamides. Suitable polyamides are all the polyamides known to a person skilled in the art, comprising semi-crystalline and amorphous polyamides that are melt-processable. Examples of suitable polyamides according to the invention are aliphatic polyamides, for example PA-6, PA-11, PA-12, PA4,6, PA-4,8, PA-4,10, PA-4,12, PA-6,6, PA-6,9, PA-6,10, PA-6,12, PA-10,10, PA-12,12, PA-6/6,6-copolyamide, PA-6/12-copolyamide, PA-6/11-copolyamide, PA-6,6/11-copolyamide, PA-6,6/12-copolyamide, PA-6/6,10-copolyamide, PA-6,6/6,10-copolyamide, PA-4,6/6-copolyamide, PA-6/6,6/6,10-terpolyamide, and copolyamides obtained from 1,4-cyclohexanedicarboxylic acid and 2,2,4- and 2,4,4-trimethylhexamethylenediamine, aromatic polyamides, for example PA-6,I, PA-6,I/6,6-copolyamide, PA-6,T, PA-6,T/6-copolyamide, PA-6,T/6,6-copolyamide, PA-6,I/6,T-copolyamide, PA-6,6/6,T/6,I-copolyamide, PA-6,T/2-MPMDT-copolyamide (2-MPMDT=2-methylpentamethylene diamine), PA-9,T, copolyamides obtained from terephthalic acid, 2,2,4- and 2,4,4-trimethylhexamethylenediamine, copolyamide obtained from isophthalic acid, laurinlactam and 3,5-dimethyl-4,4-diamino-dicyclohexylmethane, copolyamides obtained from isophthalic acid, azelaic acid and/or sebacic acid and 4,4-diaminodicyclohexylmethane, copolyamides obtained from caprolactam, isophthalic acid and/or terephthalic acid and 4,4-diaminodicyclohexyl-methane, copolyamides obtained from caprolactam, isophthalic acid and/or terephthalic acid and isophoronediamine, copolyamides obtained from isophthalic acid and/or terephthalic acid and/or other aromatic or aliphatic dicarboxylic acids, optionally alkyl—substituted hexamethylenediamine and alkyl-substituted 4,4-diaminodicyclohexylamine, and also copolyamides and mixtures of the aforementioned polyamides.

More preferably, the thermoplastic polymer comprises a semi-crystalline polyamide. Semi-crystalline polyamides have the advantage of having good thermal properties and mould filling characteristics.

Also still more preferably, the thermoplastic polymer comprises a semi-crystalline polyamide with a melting point of at least 200° C., more preferably at least 220° C., 240° C., or even 260° C. and most preferably at least 280° C. Semi-crystalline polyamides with a higher melting point have the advantage that the thermal properties are further improved.

With the term melting point is herein understood the temperature measured by DSC with a heating rate of 5° C. falling in the melting range and showing the highest melting rate.

Preferably a semi-crystalline polyamide is chosen from the group comprising PA-6, PA-6,6, PA-6,10, PA-4,6, PA-11, PA-12, PA-12,12, PA-6,I, PA-6,T, PA-6,T/6,6-copolyamide, PA-6,T/6-copolyamide, PA-6/6,6-copolyamide, PA-6,6/6,T/6,I-copolyamide, PA-6,T/2-MPMDT- copolyamide, PA-9,T, PA-4,6/6-copolyamide and mixtures and copolyamides of the aforementioned polyamides. More preferably PA-6,I, PA-6,T, PA-6,6, PA-6,6/6T, PA-6,6/6,T/6,I-copolyamide, PA-6,T/2-MPMDT-copolyamide, PA-9,T or PA-4,6, or a mixture or copolyamide thereof, is chosen as the polyamide. Still more preferably, the semi-crystalline polyamide comprises PA-4,6. The advantage of PA-46 is that the fogging is even further reduced.

For the thermally conductive material in the thermally conductive plastic composition any material that can be dispersed in the thermoplastic polymer and that improves the thermal conductivity of the plastic composition can be used. Suitable thermally conductive materials include, for example, aluminium, alumina, copper, magnesium, brass, carbon, silicon nitride, aluminium nitride, boron nitride, zinc oxide, glass, mica, graphite, ceramic fibre and the like. Mixtures of such thermally conductive materials are also suitable.

The thermally conductive material may be in the form of granular powder, particles, whiskers, short fibres, or any other suitable form. The particles can have a variety of structures. For example, the particles can have flake, plate, rice, strand, hexagonal, or spherical-like shapes.

The thermally conductive material suitably is a thermally conductive filler or a thermally conductive fibrous material, or a combination thereof. A filler is herein understood to be a material consisting of particles with an aspect ratio of less than 10:1. Suitably, the filler material has an aspect ratio of about 5:1 or less. For example, boron nitride granular particles having an aspect ratio of about 4:1 can be used. A fibre is herein understood to be a material consisting of particles with an aspect ratio of at least 10:1. More preferably the thermally conductive fibers consisting of particles with an aspect ratio of at least 15:1, more preferably at least 25:1.

For the thermally conductive fibers in the thermally conductive plastic composition any fibers that improve the thermal conductivity of the plastic composition can be used. Suitably, the thermally conductive fibers comprise glass fibres, metal fibres and/or carbon fibres. Suitable carbon-fibres, also known as graphite fibres, include PITCH-based carbon fibre and PAN-based carbon fibres. For example, PITCH-based carbon fibre having an aspect ratio of about 50:1 can be used. PITCH-based carbon fibres contribute significantly to the heat conductivity. On the other hand PAN-based carbon fibres have a larger contribution to the mechanical strength.

The choice of thermally conductive material will depend on the further requirements for the lamp socket and the amounts that have to be used depend on the type of thermally conductive material and the level of heat conductivity required. The plastic composition in the lamp socket according to the invention suitably comprises 30-90 wt % of the thermoplastic polymer and 10-70 wt % of the thermally conductive material, preferably 40-80 wt % of the thermoplastic polymer and 20-60 wt % of the thermally conductive material, wherein the wt % are relative to the total weight of the plastic composition. It is noted that for the amount of 10 wt. % might be sufficient for one type of thermally conductive material to attain a through plane thermal conductivity of at least 0.5 W/m.K, such as for specific grades of graphite, whereas for others, such as pitch carbon fibres, boron nitride and in particular glass fibres, much higher wt. % are needed. The amounts necessary to attain the required levels can be determined by the person skilled in the art of making thermally conductive polymer compositions by routine experiments.

Preferably, both low aspect and high aspect ratio thermally conductive materials, i.e. both thermally conductive fillers and fibres, are comprised by the plastic composition, as described in McCullough, U.S. Pat. Nos. 6,251,978 and 6,048,919, the disclosure of which are hereby incorporated by reference.

In a preferred embodiment of the invention, the thermally conductive filler comprises boron nitride. The advantage of boron nitride as the thermally conductive filler in the plastic composition from which the lamp socket is made is that it imparts a high thermal conductivity while retaining good electrical insulating properties.

In another preferred embodiment of the invention, the thermally conductive filler comprises graphite,. The advantage of graphite as the thermally conductive filler in the plastic composition from which the lamp socket is made is that it imparts a high thermal conductivity already at a very low weight percentage.

Also preferably, the thermally conductive fibers comprise or even consist of glass fibres. The advantage of glass fibres in the thermally conductive plastic composition from which the lamp socket is made is that the lamp socket has a good heat conductivity and lower fogging, increased mechanical strength and retains a good electrical isolation. Since glass is not one of the most effective thermally conductive materials, it is suitably be combined with a thermally conductive filler. More preferably, the thermally conductive plastic composition in the lamp socket according to the invention comprises both glass fibres and boron nitride. Even more preferable, the glass fibres and boron nitride are present in a weight ratio between 5:1 and 1:5, preferably between 2.5:1 and 1:2.5.

The plastic composition from which the lamp socket according to the invention is made, may also comprise, next to the thermoplastic polymer and the thermally conductive material, also other components, denoted herein as additives. As additives, the thermally conductive material may comprise any auxiliary additive, known to a person skilled in the art that are customarily used in polymer compositions. Preferably, these other additives should not detract, or not in a significant extent, from the invention. Whether an additive is suitable for use in the lamp socket according to the invention can be determined by the person skilled in the art of making polymer compositions for lamp sockets by routine experiments and simple tests. Such other additives include, in particular, non-conductive fillers and non-conductive reinforcing agents, pigments, dispersing aids, processing aids, for example lubricants and mould release agents, impact modifiers, plasticizers, crystallization accelerating agents, nucleating agents, UV stabilizers, antioxidants and heat stabilizers, and the like. In particular, the thermally conductive plastic composition contains a non-conductive inorganic filler and/or non-conductive reinforcing agent. Suitable for use as a non-conductive inorganic filler or reinforcing agent are all the fillers and reinforcing agents known to a person skilled in the art, and more particular auxiliary fillers, not considered thermally conductive fillers. Suitable non-conductive fillers are, for example asbestos, mica, clay, calcined clay and talcum.

These additives are suitably present, if any, in a total amount of 0-50 wt. %, preferably 0.5-25 wt. %, more preferably 1-12.5 wt. % relative to the total weight of the plastic composition.

The non-conductive fillers and fibres are preferably present, if any, in a total amount of 0-40 wt. %, preferably 0.5-20 wt. %, more preferably 1-10 wt. %, relative to the total weight of the composition, whereas the other additives are preferably present, if any, in a total amount of 0-10 wt. %, preferably 0.25-5 wt. %, more preferably 0.5-2.5 wt. %, relative to the total weight of the plastic composition.

In a preferred embodiment of the invention, the lamp socket is made of a plastic composition consisting of:
a) 30-90 wt. % of thermoplastic polymer
b) 10-70 wt. % of thermally conductive material
c) 0-50 wt. % of additives
   wherein the wt. % of (a), (b) and (c) is relative to the total weight of the plastic composition a sum of (a), (b) and (c) is 100 wt. %.

More preferably, the plastic composition consists of:
a) 30-90 wt. % of thermoplastic polymer
b) 15-70 wt. % of thermally conductive material at least 50 wt. % thereof consist of glass fibres and boron nitride in a weight ratio between 5:1 and 1:5, and
c) (i) 0-40 wt. % of non-conductive fillers and/ or non-conductive fibres, and (ii) 0-10 wt. % of other additives
   wherein the wt. % of (a), (b), (c)(i) and (c)(ii) are relative to the total weight of the plastic composition a sum of (a), (b), (c)(i) and (c)(ii) is 100 wt. %.

Also more preferably, the plastic composition consists of:
a) 30-90 wt. % of a semi-crystalline polyamide with a melting point of at least 200° C.
b) 10-70 wt. % of thermally conductive material at least 50 wt. % thereof consist of graphite,
c) (i) 0-20 wt. % of non-conductive fillers and/ or non-conductive fibres, and (ii)0-5 wt. % of other additives
   wherein the wt. % of (a), (b), (c)(i) and (c)(ii) are relative to the total weight of the plastic composition a sum of (a), (b), (c)(i) and (c)(ii) is 100 wt. %.

It is noted that in these preferred embodiments the minimum amount of thermally conductive material is governed by the required minimum thermal conductivity of the plastic composition and the type of thermally conductive material, or combinations thereof, used therein. As an indicative example, the amounts in which the thermally conductive material may be used, in particular when used, can vary within different ranges, for example, boron nitride is preferably used in an amount in the range of 15-60 wt. %, more preferably 20-45 wt. %, carbon pitch fibre is preferably used in an amount in the range of 15-60 wt. %, more preferably 25-60 wt. %, whereas graphite is preferably used in an amount in the range of 10-45 wt. %, more preferably 15-30 wt. %.

The thermally conductive plastic composition that is used for making the lamp socket according to the invention can be made by any process that is suitable for making plastic compositions and includes the conventional processes known by the person skilled in the art of making plastic compositions for melding applications.

The thermally conductive plastic composition suitable is made by a process wherein the thermally conductive material is intimately mixed with the non-conductive polymer matrix to form the thermally conductive composition. The loading of the thermally conductive material imparts thermal conductivity to the polymer composition. If desired, the mixture may contain one or more other additives. The mixture can be prepared using techniques known in the art. Preferably, the ingredients are mixed under low shear conditions in order to avoid damaging the structure of the thermally conductive filler materials.

The lamp socket according to the invention can be made from the thermally conductive plastic composition by any process that is suitable for making moulded plastic parts and includes the conventional processes known by the person skilled in the art of making moulded plastic compositions.

The polymer composition can be moulded into the lamp socket using a melt-extrusion, injection moulding, casting, or other suitable process. An injection-melding process is particularly preferred. This process generally involves loading pellets of the composition into a hopper. The hopper funnels the pellets into an extruder, wherein the pellets are heated and a molten composition forms. The extruder feeds the molten composition into a chamber containing an injection piston. The piston forces the molten composition into a mould. Typically, the mould contains two moulding sections that are aligned together in such a way that a moulding chamber or cavity is located between the sections. The material remains in the mould under high pressure until it cools. The shaped lamp socket is then removed from the mould.

Preferably, the lamp socket according to the invention is made from a thermally conductive plastic composition comprising thermally conductive fibres and thermally conductive fillers by an injection melding process.

Further, the lamp socket of this invention preferably is net shape moulded. This means that the final shape of the socket is determined by the shape of the moulding sections. No additional processing or tooling is required to produce the ultimate shape of the lamp socket. This moulding process enables the integration of the thermally dissipating elements directly into the lamp socket.

This invention relates also relates to an automotive lamp assembly comprising a lamp socket according to the present invention or any preferred embodiment thereof as described herein above. The automotive lamp assembly preferably is for automotive exterior lighting, for example, for front lighting or rear lighting.

The invention is further illustrated with the following examples and comparative experiments.

### Materials

Moulding compositions were prepared from polyamide-46 and carbon pitch fiber, and boron nitride, respectively, in an extruder using standard melt compounding process. From the compositions test samples with dimensions of 80×80×1 mm were prepared by injection moulding using an injection moulding machine equipped with a square mould with the proper dimensions and a film gate of 80 mm wide and 1 mm high positioned at one side of the square. Of the 1 mm thick injection molded plaques the thermal diffusivity D, the density (ρ) and the heat capacity (Cp) was determined.

The thermal diffusivity was determined in a direction in-plane and parallel (D_{//}) and in-plane and perpendicular (D_{±}) to the direction of polymer flow upon mold filling, as well as through plane (D_{⊥}), according to ASTM E1461-01 with Netzsch LFA 447 laserflash equipment. The in-plane thermal diffusivities D_{//} and D_{±} were determined by first cutting small strips or bars with an identical width of about 1 mm wide from the plaques. The length of the bars was in the direction of, respectively perpendicular to, the polymer flow upon mold filling. Several of these bars were stacked with the cut surfaces facing outwards and clamped very tightly together. The thermal diffusivity was measured through the stack from one side of the stack formed by an array of cut surfaces to the other side of the stack with cut surfaces.

The heat capacity (Cp) of the plates was determined by comparison to a reference sample with a known heat capacity (Pyroceram 9606), using the same Netzsch LFA 447 laserflash equipment and employing the procedure described by W. Nunes dos Santos, P. Mummery and A. Wallwork, Polymer Testing 14 (2005), 628-634.

From the thermal diffusivity (D), the density (ρ) and the heat capacity (Cp), the thermal conductivity of the molded plaques was determined in a direction parallel (Λ_{//}) and perpendicular (Λ_{±}) to the direction of polymer flow upon mold filling, as well as perpendicular to the plane of the plaques (Λ_{⊥}), according to formula (V):

Λₓ=Dₓ*ρ*Cp (V)

wherein x=//, ± and ⊥, respectively.

The conductivity data have been collected in Table I.

From the compositions lamp sockets were prepared by injection moulding using an injection moulding machine equipped with a standard lamp socket mould. The moulded lamp sockets were used in a set-up wherein the lamp sockets were heated to ° C. for . . . hours, while being covered with a cooled watch glass. After the heat treatment the watch glass was visually inspected for fogging and rated. The rating results have been collected as well in Table 1.

TABLE 1
Material compositions (wt. %), thermal conductivity
data (W/mK) and haze evaluation ^{a)} for Comparative
Experiment A and Examples I-VIII.

| | PA46 | CPF | EG | BN | Λ_{⊥} | Λ_{//} | Λₒₐ | Haze |
|---|---|---|---|---|---|---|---|---|
| CE A | 100 | | | | 0.3 | 0.3 | 0.3 | 5 |
| EX I | 85 | 15 | | | 0.5 | 2.1 | 1.03 | 4 |
| EX II | 70 | 30 | | | 0.6 | 4.1 | 1.8 | 3 |
| EX III | 55 | 45 | | | 0.9 | 6.0 | 2.6 | 2 |
| EX IV | 40 | 60 | | | 1.1 | 8.2 | 3.5 | 1-2 |
| EX V | 85 | | | 15 | 0.5 | 1.4 | 1.1 | 4-5 |
| EX VI | 70 | | | 30 | 0.7 | 3.6 | 2.6 | 2-3 |
| EX VII | 55 | | | 45 | 0.9 | 7.8 | 5.5 | 1-2 |
| EX VIII | 40 | | | 60 | 1.5 | 13.5 | 9.5 | 1 |

^{a)} Haze rating: 1 = excellent, 5 is very bad

1. Lamp socket consisting at least partially of a plastic composition having a through plane thermal conductivity of at least 0.5 W/m.K.

2. Lamp socket according to claim 1, wherein the through plane thermal conductivity is 1-15 W/m.K.

3. Lamp socket according to claim 1, wherein the plastic composition comprises a thermoplastic polymer and thermally conductive material dispersed in the thermoplastic polymer.

4. Lamp socket according to claim 1, wherein the plastic composition has a heat distortion temperature (HDT-B) of at least 180° C.

5. Lamp socket according to claim 3, wherein the thermoplastic polymer is chosen from the group consisting of polyesters, polyamides, polyphenylene sulphides, polyphenylene oxides, polysulfones, polyarylates, polyetheretherketones, and polyetherimides, and mixtures and/or copolymers thereof.

6. Lamp socket according to claim 3, wherein the thermally conductive material is a thermally conductive filler or a thermally conductive fibrous material, or a combination thereof.

7. Lamp socket according to claim 3 wherein the plastic composition comprises thermally conductive filler comprising boron nitride.

8. Lamp socket according to claim 3, wherein the plastic composition comprises thermally conductive fibrous material comprising glass fibres.

9. Lamp socket according to claim 7, wherein the plastic composition comprises glass fibres and boron nitride in a total amount of 10-70 wt. %, relative to the total weight of the plastic composition.

10. Lamp socket according to claim 7, wherein the plastic composition comprises a semicrystalline polyamide having a melting point of at least 200° C., glass fibres and boron nitride.

11. Automotive lamp assembly comprising a lamp socket according to according to claim 1.
